(19) United States
(12) Patent Application Publication
(10) Pub. No.: US 2014/0063535 A1
(43) Pub. Date: Mar. 6, 2014

(54) IMAGE FORMING APPARATUS, IMAGE FORMING SYSTEM, AND RECORDING MEDIUM

(71) Applicant: Konica Minolta, Inc., Chiyoda-ku (JP)

(72) Inventors: Tomokazu KATO, Toyokawa-shi (JP); Hiroki UEDA, Toyohashi-shi (JP); Kaoru FUKUOKA, Toyokawa-shi (JP); Mitsutaka MORITA, Nagoya-shi (JP)

(73) Assignee: Konica Minolta, Inc., Chiyoda-ku (JP)

(21) Appl. No.: 14/015,310

(22) Filed: Aug. 30, 2013

(30) Foreign Application Priority Data
Sep. 3, 2012 (JP) 2012-192797

(51) Int. Cl. G06K 15/00

(52) U.S. Cl. CPC G06K 15/4095
USPC 358/1.14

(57) ABSTRACT

Provided is an image forming apparatus including: an input-operation accepting unit configured to accept an input operation by a first user currently logged in the image forming apparatus; a receiving unit configured to receive an authenticated printing job from a second user different from the first user; a storing unit configured to store the authenticated printing job in association with the second user; an authenticating unit provided separately from the input-operation accepting unit, and configured to authenticate the second user in parallel with acceptance processing of the input operation by the first user using the input-operation accepting unit; an extracting unit configured to extract the authenticated printing job associated with the second user from the storing unit upon authentication of the second user by the authenticating unit; and a print control unit configured to execute and print the authenticated printing job extracted by the extracting unit.

This application is based on Japanese Patent Application No. 2012-192797 filed on Sep. 3, 2012, the contents of which are hereby incorporated by reference.

### BACKGROUND OF THE INVENTION

1. Field of the Invention

The present invention relates to an image forming apparatus and a technique relating to such an apparatus.

2. Description of the Background Art

Conventionally, there is known a technique of requesting a user to log in when using an image forming apparatus. Image forming apparatuses of this type include an image forming apparatus capable of executing a job of a user who newly logs in when there is a user who has already logged in.

For example, Japanese Unexamined Patent Application Publication No. 2008-193474 discloses a technique of, when a user 1 (user 1) has already logged in an image processing apparatus, allowing a different user 2 (user 2) to log in the image processing apparatus and executing print processing. Specifically, if the user 2 presses an ID key in a state in which a print setting screen for the user 1 who has already logged in the image processing apparatus is displayed in a touch panel unit, a log-in screen is displayed superposed over the print setting screen. Then, when a user ID and a password of the user 2 are inputted via the log-in screen, the user 2 is allowed to log in and print processing by the user 2 is executed.

Further, the image forming apparatuses include an image forming apparatus capable of executing an authenticated printing job (described next). The authenticated printing job is a printing job that is transmitted to an image forming apparatus from a personal computer and the like and stored temporarily in the image forming apparatus, and then executed when a user who has assigned a print instruction of the printing job moves to an installation site of this image forming apparatus and authenticated by an authenticating unit of the image forming apparatus.

According to the technique disclosed in Japanese Unexamined Patent Application Publication No. 2008-193474, even if there is a login user (user 1) currently logged in the image forming apparatus, a different user (user 2) who is different from this login user may be authenticated via the log-in screen displayed in the touch panel unit. Therefore, the different user (user 2) is able to execute the authenticated printing job that requires user authentication of this different user.

However, according to the technique disclosed in Japanese Unexamined Patent Application Publication No. 2008-193474, in the login processing of the user 2, the log-in screen (the operation screen for the user 2) is displayed superposed over the print setting screen (the operation screen for the user 1) displayed in the touch panel unit (an input-operation accepting unit), and therefore an operation to the touch panel unit (print setting operation) by the user 1 is adversely inhibited.

### SUMMARY OF THE INVENTION

An object of the present invention is to provide a technique capable of executing an authenticated printing job of a user different from a login user currently logged in an image forming apparatus, without inhibiting an operation to an input-operation accepting unit by the login user.

A first aspect of the present invention provides an image forming apparatus including: an input-operation accepting unit configured to accept an input operation by a first user currently logged in the image forming apparatus; a receiving unit configured to receive an authenticated printing job from a second user different from the first user; a storing unit configured to store the authenticated printing job in association with the second user; an authenticating unit provided separately from the input-operation accepting unit, and configured to authenticate the second user in parallel with acceptance processing of the input operation by the first user using the input-operation accepting unit; an extracting unit configured to extract the authenticated printing job associated with the second user from the storing unit upon authentication of the second user by the authenticating unit; and a print control unit configured to execute the authenticated printing job extracted by the extracting unit.

A second aspect of the present invention provides an image forming system including: an input-operation accepting unit configured to accept an input operation by a first user currently logged in an image forming apparatus; a receiving unit configured to receive an authenticated printing job from a second user different from the first user; a storing unit configured to store the authenticated printing job in association with the second user; an authenticating unit provided separately from the input-operation accepting unit, and configured to authenticate the second user in parallel with acceptance processing of the input operation by the first user using the input-operation accepting unit; an extracting unit configured to extract the authenticated printing job associated with the second user from the storing unit upon authentication of the second user by the authenticating unit; and a print control unit configured to execute the authenticated printing job extracted by the extracting unit.

A third aspect of the present invention provides a non-transitory computer-readable recording medium storing a program for causing a computer built within an image forming apparatus to execute the steps of: a) accepting an input operation by a first user currently logged in the image forming apparatus using an input-operation accepting unit; b) receiving an authenticated printing job from a second user different from the first user; c) storing the authenticated printing job in association with the second user in a storing unit; d) authenticating the second user using an authenticating unit provided separately from the input-operation accepting unit and configured to perform user authentication in parallel with acceptance processing of the input operation by the first user using the input-operation accepting unit; e) extracting the authenticated printing job associated with the second user from the storing unit upon authentication of the second user by the authenticating unit; and f) executing the authenticated printing job extracted in the step e).

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram schematically illustrating a configuration of an image forming system;

FIG. 2 is a functional block diagram schematically illustrating a configuration of an image forming apparatus;

FIG. 3 is a table illustrating accumulated job information;

FIG. 4 is a flowchart showing an operation of the image forming apparatus;

FIG. 5 is a flowchart showing an operation of the image forming apparatus;

FIG. 6 is a flowchart showing an operation of the image forming apparatus;

FIG. 7 is a flowchart showing an operation according to a modified example of the image forming apparatus;

FIG. 8 is a flowchart showing an operation according to a modified example of the image forming apparatus; and

FIG. 9 is a flowchart showing an operation according to a modified example of the image forming apparatus.

### DESCRIPTION OF THE PREFERRED EMBODIMENTS

<1. Overall Configuration>

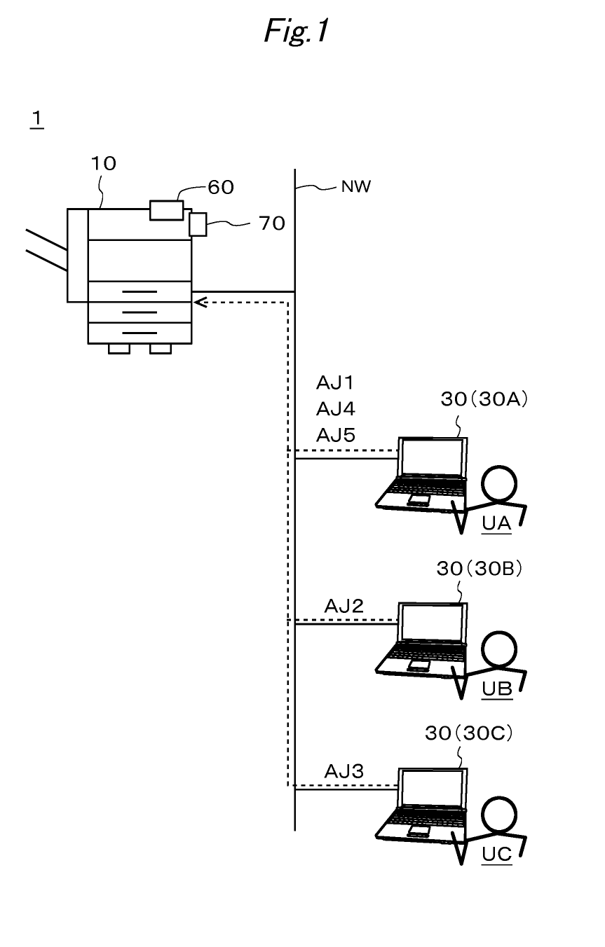

FIG. 1 is a diagram illustrating an image forming system 1 according to an embodiment. Referring to FIG. 1, the image forming system 1 is provided with an image forming apparatus 10 and a plurality of client computers 30 (specifically, 30A, 30B, and 30C). The image forming apparatus 10 and the client computers 30 are connected to each other via a network NW.

Users UA, UB, and UC own the client computers 30A, 30B, and 30C, respectively (see FIG. 1). Each of the users UA, UB, and UC is able to transmit an authenticated printing job AJ to the image forming apparatus 10 using a corresponding one of the client computers 30A, 30B, and 30C. The authenticated printing job is a printing job that is transmitted to the image forming apparatus 10 from a personal computer and the like and temporarily stored in the image forming apparatus 10, and then executed when a user who has assigned a print instruction of the printing job moves to an installation site of the image forming apparatus 10 and authenticated by an authenticating unit 70 (described later) of the image forming apparatus 10.

In this embodiment, an MFP (Multi-functional Peripheral) is described as an example of the image forming apparatus 10.

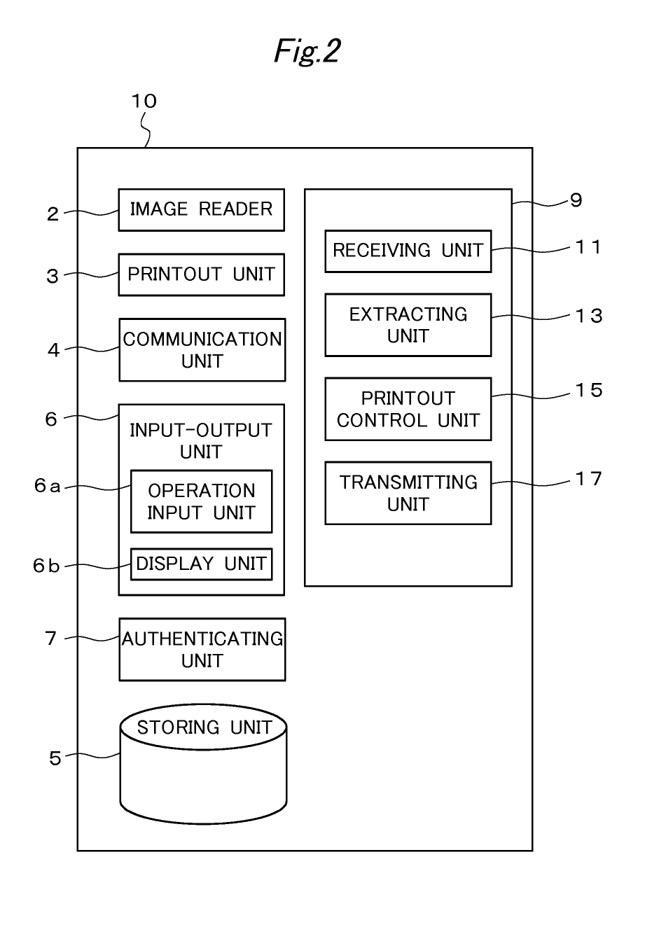

FIG. 2 is a functional block diagram schematically illustrating a configuration of the MFP 10.

The MFP 10 is an apparatus (also referred to as a multifunction device) provided with functions such as a scanning function, a copying function, a facsimile function, and a box storage function. Specifically, as illustrated in the functional block diagram in FIG. 2, the MFP 10 is provided with an image reader 2, a printout unit 3, a communication unit 4, a storing unit 5, an input-output unit 6, an authentication processing unit 7, a controller 9, and the like, and realizes the various functions by multiple operations of these components.

The image reader 2 is a processor that optically reads (i.e., scans) a document placed on a predetermined position of the MFP 10 and generates image data of this document (also referred to as a document image or a scanned image). The image reader 2 is also referred to as a scanner.

The printout unit 3 is an output unit that prints an image on a medium of a variety of types, such as paper, based on data relating to a printing object.

The communication unit 4 is a processor that is able to perform facsimile communication via the public line and the like. Further, the communication unit 4 is also able to perform network communication via the network NW. In the network communication, any of various protocols such as TCP/IP (Transmission Control Protocol/Internet Protocol) can be used, for example. By using such a network communication, the MFP 10 is able to receive or transmit various data from or to a desired target. The MFP 10 is also able to transmit or receive e-mail utilizing this network communication.

The storing unit 5 is configured by a storage device such as a hard disk drive (HDD). The storing unit 5 stores user authentication information (including a user ID and a password for authentication).

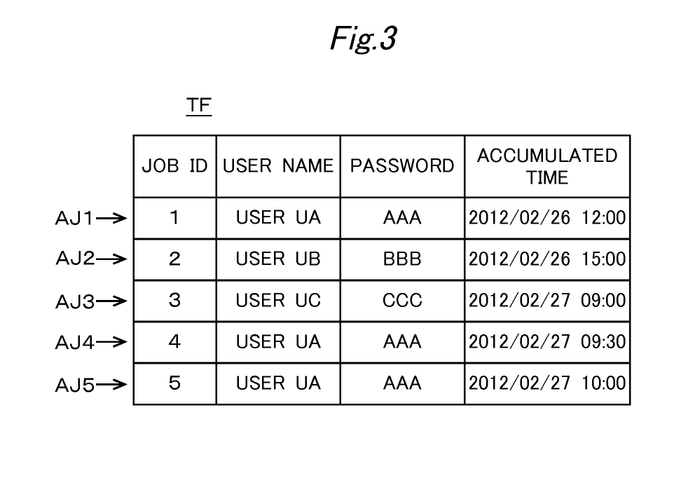

Further, the storing unit 5 stores the authenticated printing jobs AJ transmitted from the client computers 30 (30A to 30B), and accumulated job information TF recording information related to the authenticated printing jobs AJ (see FIG. 3).

Referring to FIG. 3, the accumulated job information TF records information related to a plurality of items related to each of the authenticated printing jobs AJ (specifically, a “job ID”, a “user name”, a “password ” and “accumulated time”).

The “job ID” records a job ID assigned to each of the authenticated printing jobs AJ when the corresponding job is stored in the storing unit 5.

The “user name” records a name of the user who has registered the corresponding authenticated printing job AJ.

The “password” records a password set for the corresponding authenticated printing job AJ.

The “accumulated time” records time at which the corresponding authenticated printing job AJ is stored (accumulated) in the storing unit 5.

The input-output unit 6 includes an operation input unit 6a for accepting an input operation from the user to the MFP 10 and a display unit 6b for outputting and displaying various information. The MFP 10 is provided with an operation panel 60 (see FIG. 1). The operation panel 60 is configured such that a piezoelectric sensor or the like is embedded in a liquid crystal display panel, and functions as a part of the operation input unit 6a as well as a part of the display unit 6b. The operation panel 60 functions as an input-operation accepting unit or the like that accepts an input operation related to setting of a job and the like by a login user currently logged in the MFP 10.

The authentication processing unit 7 is a processor for authenticating the user based on the user authentication information stored in the storing unit 5. The authentication processing unit 7 includes the authenticating unit 70 (see FIG. 1). The authenticating unit 70 is provided separately from the operation panel 60. The authenticating unit 70 is able to authenticate a different user different from the login user in parallel with acceptance processing of the input operation by the login user using the operation panel 60. Here, the authenticating unit 70 is configured as an IC card reader that reads information recorded in an IC card (smart card).

The controller 9 realizes various processors by a CPU executing a predetermined software program (hereinafter, also simply referred to as a program) PG1 stored in an ROM (e.g., EEPROM or the like). Specifically, the controller 9 realizes various processors including a receiving unit 11, an extracting unit 13, a printout control unit 15, and a transmitting unit 17.

The receiving unit 11 is a processor for receiving various data. For example, the receiving unit 11 receives the authenticated printing jobs AJ transmitted from the client computers 30.

The extracting unit 13 is a processor for extracting one of the authenticated printing jobs AJ associated with a specific user from the storing unit 5 when this specific user (hereinafter also referred to as an authenticated user) is authenticated by the authentication processing unit 7.

The printout control unit 15 is a processor for executing the printing job to print out in cooperation with the printout unit 3. Specifically, the printout control unit 15 performs printout of the authenticated printing job AJ extracted from the storing unit 5 by the extracting unit 13.

The transmitting unit 17 is a processor for transmitting various data. For example, the transmitting unit 17 transmits information related to one of the authenticated printing jobs AJ for which printout in the printout control unit 15 is failed (hereinafter also referred to as an NG job) to a transmitting user as a sender of this authenticated printing job AJ. Specifically, the transmitting unit 17 transmits the information related to the NG job in e-mail as an NG list to the user who has transmitted the authenticated printing job AJ. The NG list includes the job ID, a job name, and the like of the NG job.

The client computers 30 are computers each capable of executing various application software programs. In each client computer 30, a printer driver (software program) is installed, and the client computer 30 transmits the authenticated printing job AJ to the MFP 10 using this printer driver.

<2. Operation>

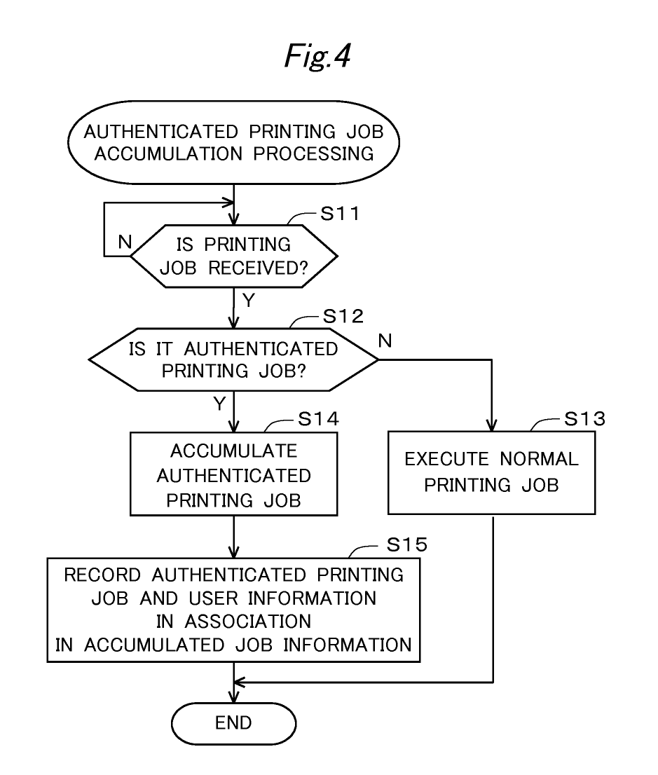

Next, an operation of the MFP 10 according to the embodiment will be described in detail with reference to FIG. 4 through FIG. 6. FIG. 4 through FIG. 6 are flowcharts showing the operation of the MFP 10. In the following description, accumulation processing by the authenticated printing job AJ will be first described, and then printout processing of the authenticated printing job AJ will be described.

<2-1. Accumulation Processing by Authenticated Printing Job AJ>

When a specific printing job is received from any of the client computers 30 (YES in Step S11 of FIG. 4), the MFP 10 determines whether or not this specific printing job is the authenticated printing job AJ (Step S12).

Here, if the specific printing job is determined not to be the authenticated printing job AJ (NO in Step S12), the specific printing job is determined to be a normal printing job, and the MFP 10 executes the normal printing job immediately to print out (Step S13).

On the other hand, if the specific printing job is determined to be the authenticated printing job AJ (YES in Step S12), the MFP 10 temporarily stores (accumulates) the authenticated printing job AJ in the storing unit 5 (Step S14). Then, the MFP 10 records information related to the authenticated printing job AJ stored in the storing unit 5 in the accumulated job information TF (see FIG. 3) (Step S15).

For example, when an authenticated printing job AJ1 by the user UA is transmitted from the client computer 30A, the MFP 10 stores (accumulates) the authenticated printing job AJ1 in the storing unit 5. At the same time, the MFP 10 records information related to the authenticated printing job AJ1 in the accumulated job information TF (specifically, a first line of the accumulated job information TF) (see FIG. 3). Specifically, as illustrated in FIG. 3, the MFP 10 records a job ID “1” that has been assigned to the authenticated printing job AJ1 when stored in the storing unit 5 in the “job ID”, and the “user UA” as the sender of the authenticated printing job AJ1 in the “user name”. In addition, the MFP 10 records a password “AAA” set for the authenticated printing job AJ1 in the “password”, and accumulated time “2012/02/26 12:00” at which the authenticated printing job AJ1 is accumulated in the storing unit 5 in the “accumulated time”.

When authenticated printing jobs AJ2 to AJ5 other than the authenticated printing job AJ1 are transmitted, the MFP 10 also executes the processing in the flowchart of FIG. 4. Then, the MFP 10 stores the authenticated printing jobs AJ2 to AJ5 in the storing unit 5, and records information related to the authenticated printing jobs AJ2 to AJ5 in the accumulated job information TF.

It is assumed herein that the five authenticated printing jobs AJ1 to AJ5 are sequentially received, and the storing unit 5 temporarily stores these authenticated printing jobs AJ1 to AJ5. Further, as illustrated in FIG. 3, the accumulated job information TF records the information related to all of the five authenticated printing jobs AJ1 to AJ5 stored in the storing unit 5.

<2-2. Printout Processing of Authenticated Printing Job AJ>

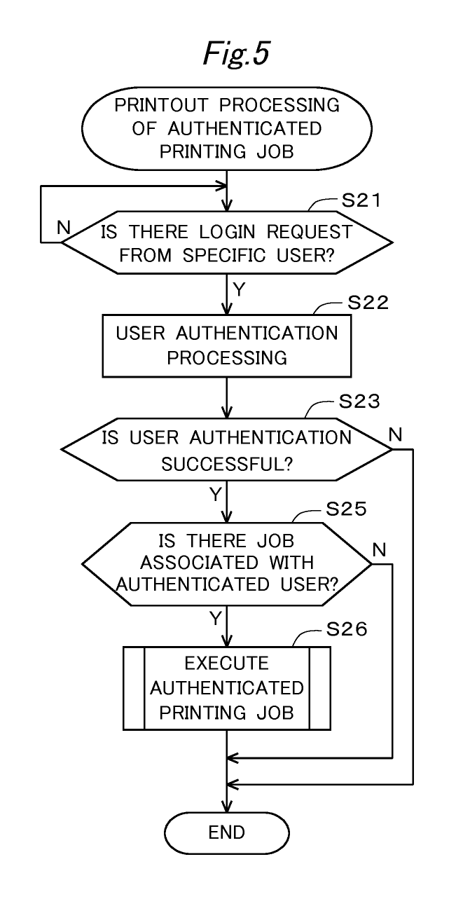

Next, the printout processing of the authenticated printing job AJ will be described with reference to FIG. 5.

In the following description, a situation is assumed that in a state in which a user UL currently logged in the MFP 10 (hereinafter also referred to as a login user) is already present, a specific user different from the login user UL (in this case, the user UA) attempts to log in the MFP 10. In this embodiment, the user UA (specific user) logs in without using the operation panel 60, but using the authenticating unit 70 provided separately from the operation panel.

In such a situation, when a login request from the user UA to the MFP 10 is accepted via the authenticating unit 70 (YES in Step S21), the authenticating unit 70 performs user authentication processing of the user UA (Step S22).

Here, upon authentication of the user UA by the authenticating unit 70 (that is, the user is successfully authenticated) (YES in Step S23), the MFP 10 determines whether or not there is any authenticated printing job AJ associated with the user UA (authenticated user) (Step S25).

In this case, since there are the authenticated printing jobs AJ1, AJ4, and AJ5 associated with the user UA (YES in Step S25), the MFP 10 executes the authenticated printing job AJ (Step S26).

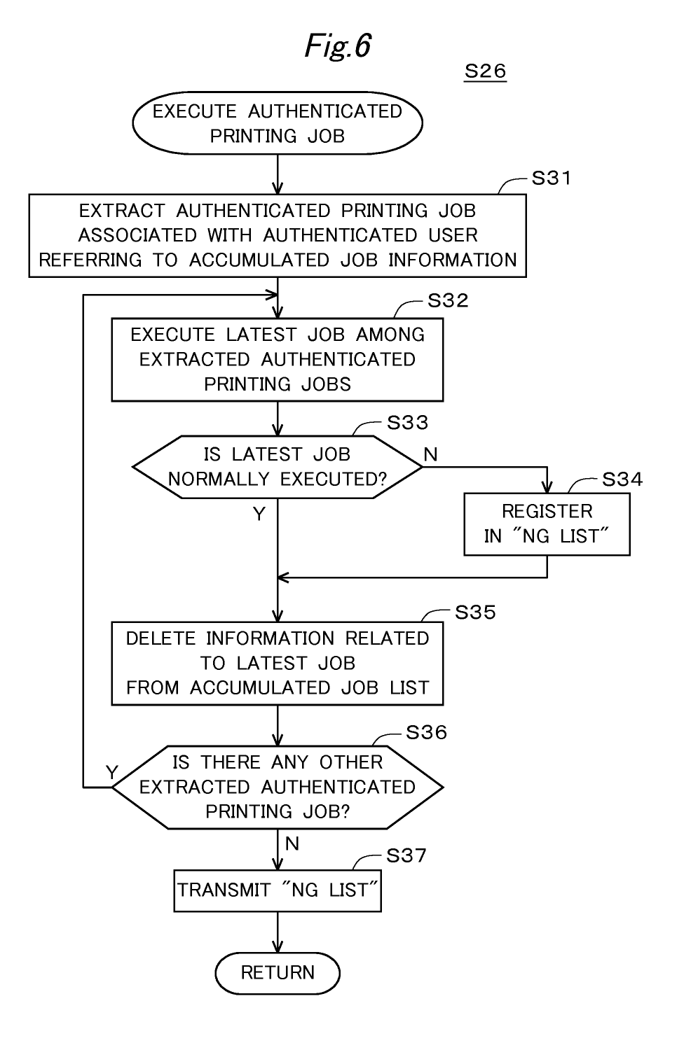

Hereinafter, an operation for executing the authenticated printing job AJ (Step S26 in FIG. 5) will be described with reference to FIG. 6.

First, the MFP 10 extracts the authenticated printing job AJ associated with the user UA (authenticated user) from the storing unit 5, referring the accumulated job information TF illustrated in FIG. 3 (Step S31). Specifically, the extracting unit 13 of the MFP 10 refers to the “user name” recorded in the accumulated job information TF, and extracts the authenticated printing jobs AJ1, AJ4, and AJ5 associated with the user UA from the storing unit 5.

Then, the MFP 10 executes and prints the authenticated printing job AJ5 last stored in the storing unit 5, out of the authenticated printing jobs AJ1, AJ4, and AJ5 extracted by the extracting unit 13 (Step S32). Specifically, the printout control unit 15 of the MFP 10 refers to the “accumulated time” in the accumulated job information TF, and executes and prints the authenticated printing job AJ5 that is latest among the authenticated printing jobs AJ1, AJ4, and AJ5.

Subsequently, the MFP 10 determines whether or not the latest authenticated printing job AJ5 is normally printed out (Step S33).

Here, if the authenticated printing job AJ5 is determined to be normally executed, the MFP 10 deletes information related to the authenticated printing job AJ5 from the accumulated job information TF (Step S35).

On the other hand, the authenticated printing job AJ5 may often not be normally printed out due to a reason such as toner out or paper out. In such a case, it is determined that the printout has not been normally done (that is, failed) in Step S33, the process moves to Step S34, and the MFP 10 registers the authenticated printing job AJ5 in the NG list as an NG job. Then, the process moves to Step S35, and the MFP 10 executes the processing in Step S35.

Subsequently, the MFP 10 determines whether or not there is any other authenticated printing job AJ extracted by the extracting unit 13 (Step S36).

Here, if it is determined that there is a different authenticated printing job AJ extracted by the extracting unit 13, the process returns to Step S32, and the processing in and after Step S32 is executed for the different authenticated printing job AJ. In this case, since there are the authenticated printing jobs AJ1 and AJ4 other than the authenticated printing job AJ5, the process returns to Step S32, and the processing in and after Step S32 is executed for the authenticated printing jobs AJ1 and AJ4. Specifically, the MFP 10 executes and prints the authenticated printing job AJ4 that is latest among the remaining authenticated printing jobs AJ1 and AJ4, and the process again returns to Step S32. Then, the MFP 10 now executes and prints the authenticated printing job AJ1.

As described above, the MFP 10 sequentially executes and prints the authenticated printing jobs AJ1, AJ4, and AJ5 associated with the user UA in an order (specifically, in the order of AJ5, AJ4, and AJ1) reverse of an order of storing in the storing unit 5 (specifically, in the order of AJ1, AJ4, and AJ5). In other words, the MFP 10 sequentially executes and prints the authenticated printing jobs AJ1, AJ4, and AJ5 from the latest one.

When all of the authenticated printing jobs AJ1, AJ4, and AJ5 are executed and printed out, it is determined that there is no other authenticated printing job AJ extracted by the extracting unit 13 in Step S36 this time, and the process moves to Step S37.

Then, the transmitting unit 17 of the MFP 10 transmits the NG list by e-mail to the user UA as the sender of the authenticated printing jobs AJ1, AJ4, and AJ5 (Step S37). Here, even if there is no NG job at all, the NG list notifying that there is no NG job is transmitted.

According to the above operation, the authenticating unit 70 capable of authenticating the user UA in parallel with acceptance processing of the input operation by the login user UL using the operation panel 60 is provided separately from the operation panel 60, and when the user UA is authenticated by the authenticating unit 70, the authenticated printing jobs AJ1, AJ4, and AJ5 associated with the user UA are executed. At this time, the user UA is not required to perform an operation to the operation panel 60. Accordingly, the operation to the operation panel 60 by the login user UL may not be inhibited by the user authentication of the user UA, and the authenticated printing jobs AJ1, AJ4, and AJ5 associated with the user UA different from the login user UL may be executed and printed out.

Further, the authenticated printing jobs AJ1, AJ4, and AJ5 associated with the user UA are sequentially executed in the order (specifically, in the order of AJ5, AJ4, and AJ1) reverse of the order of storing in the storing unit 5. In general, the authenticated printing job AJ5 for which a printout instruction is accepted immediately after registration to the MFP 10 is often given a higher priority than the authenticated printing job AJ4 that is left unattended for a while after registration to the MFP 10. Accordingly, by sequentially executing from a latest one (AJ5) of the authenticated printing jobs AJ in the order reverse of the order of storing in the storing unit 5, it is possible to preferentially execute and print the authenticated printing job AJ having a higher priority.

Further, one of the authenticated printing jobs AJ1, AJ4, and AJ5 associated with the user UA that has not been normally executed (that is, failed) (for example, AJ1) is recorded in the NG list as an NG job, and the NG list is transmitted by e-mail to the user UA who has registered the authenticated printing jobs AJ1, AJ4, and AJ5. Accordingly, it is possible to allow the user UA who has registered the plurality of authenticated printing jobs AJ1, AJ4, and AJ5 to the MFP 10 to recognize the authenticated printing job AJ for which printing is failed. In particular, if the user UA temporarily leaves the MFP 10 after being authenticated by the authenticating unit 70 and then returns to the MFP 10, the user UA may not know whether or not any of the plurality of authenticated printing jobs AJ1, AJ4, and AJ5 is failed its printing out. Even in such a case, it is possible for the user UA to certainly learn the authenticated printing jobs AJ whose printing is failed through the NG list transmitted from the MFP 10.

<3. Modified Examples, etc.>

The embodiment of the present invention has been described above, but the present invention is not limited to the example described above.

According to the embodiment, the authenticated printing jobs AJ1, AJ4, and AJ5 associated with the user UA are executed immediately after the user UA is authenticated by the authenticating unit 70 (see the flowchart of FIG. 5), but the present invention is not limited to such an example. For example, the authenticated printing jobs AJ1, AJ4, and AJ5 associated with the user UA may be executed after the user UA is authenticated by the authenticating unit 70 and after a job executed by the login user UL currently logged in the MFP 10 (specifically, a printing job accompanied by printing) is completed.

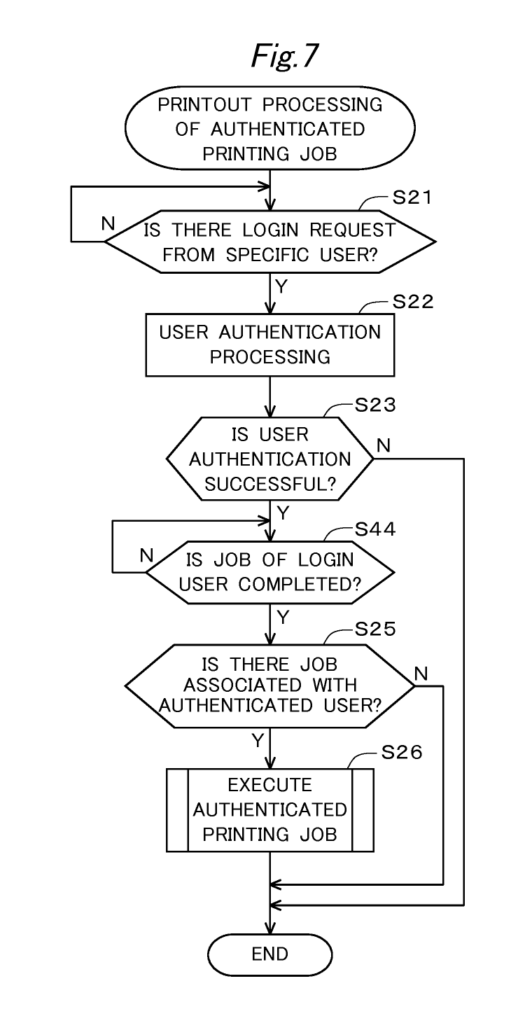

Specifically, as shown in a flowchart of FIG. 7, processing for determining whether or not a printing job by the login user UL of the MFP 10 has been completed (Step S44) may be added between Step S23 and Step S25 in the flowchart of FIG. 5. Then, the authenticated printing jobs AJ1, AJ4, and AJ5 associated with the user UA may be executed (Steps S25 and S26), under conditions that the user UA is authenticated by the authenticating unit 70 (YES in Step S23) and that the printing executed by the login user UL currently logged in the MFP 10 has been completed (YES in Step S44).

According to such a configuration, it is possible to execute the authenticated printing jobs AJ1, AJ4, and AJ5 associated with the user UA when the login user UL currently logged in the MFP 10 is not executing the printing job using the MFP 10. Accordingly, it is possible to avoid a situation in which a printout based on the printing job executed by the login user UL currently logged in the MFP 10 and printouts based on the authenticated printing jobs AJ1, AJ4, and AJ5 are present nearby in a catch tray. Thus, it is possible to suppress possibility that the printouts related to the authenticated printing jobs AJ1, AJ4, and AJ5 associated with the user UA are seen by the login user UL.

Alternatively, the authenticated printing jobs AJ1, AJ4, and AJ5 associated with the user UA (authenticated user) may be executed after the user UA is authenticated by the authenticating unit 70 and after a scanning job executed by the login user UL currently logged in the MFP 10 is completed.

According to such a configuration, it is possible to execute the authenticated printing jobs AJ1, AJ4, and AJ5 associated with the user UA when the login user UL currently logged in the MFP 10 is not executing the scanning job using the MFP 10. In other words, it is possible to execute the authenticated printing jobs AJ1, AJ4, and AJ5 associated with the user UA when the login user UL is likely to have left the MFP 10. Thus, it is possible to avoid the situation in which the printout based on the authenticated printing job AJ is fed to a catch tray during a period in which the login user UL currently logged in the MFP 10 is performing the scanning job, for example, and the login user UL who is not a rightful person who has printed the printout sees the printout.

Alternatively, the authenticated printing jobs AJ1, AJ4, and AJ5 associated with the user UA may be executed when the user UA is authenticated by the authenticating unit 70 and when a time period obtained by counting time elapsed after an input operation is last accepted by the operation panel 60 (hereinafter also referred to as a non-operating time period NT) is longer than a predetermined time period (in this case, “one minute”). If the non-operating time period NT in the operation panel 60 is longer than the predetermined time period, the operation by the login user UL is determined to be completed. Further, it is possible to have the login user UL forcibly log out when the non-operating time period NT reaches the predetermined time period, and to execute the authenticated printing jobs AJ1, AJ4, and AJ5 associated with the user UA after the logout processing.

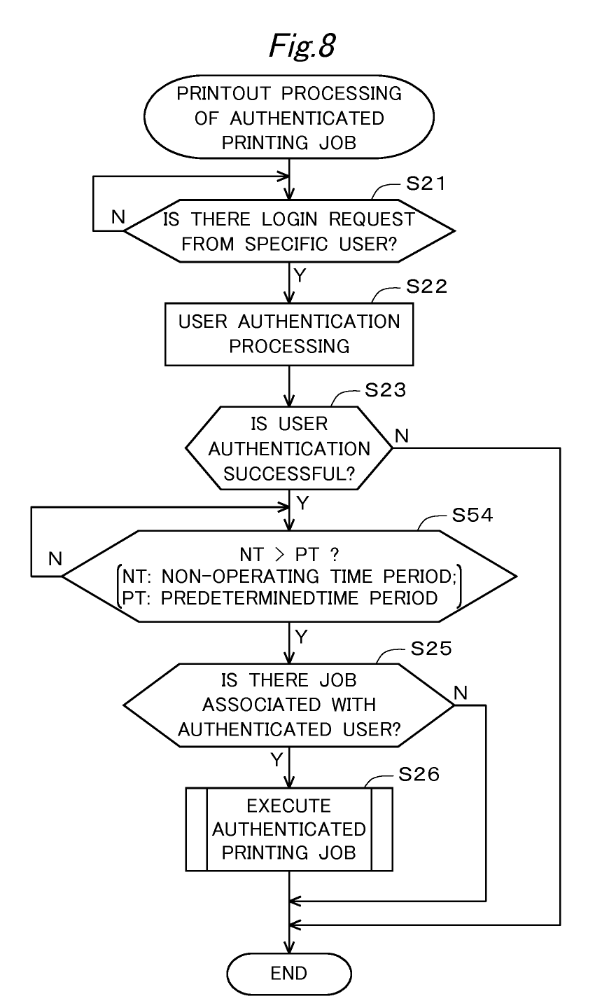

Specifically, as shown in a flowchart of FIG. 8, processing for determining whether or not the non-operating time period NT is longer than the predetermined time period (Step S54) may be added between Step S23 and Step S25 in the flowchart of FIG. 5. Then, the authenticated printing jobs AJ1, AJ4, and AJ5 associated with the user UA may be executed (Steps S25 and S26) when the user UA is authenticated by the authenticating unit 70 (YES in Step S23) and when the non-operating time period NT is determined to be longer than the predetermined time period (YES in Step S54).

According to such a configuration, it is possible to execute the authenticated printing jobs AJ1, AJ4, and AJ5 when the login user UL currently logged in the MFP 10 is likely to have stopped using the MFP 10. Thus, it is possible to suppress possibility that the printouts based on the authenticated printing jobs AJ1, AJ4, and AJ5 are seen by the login user UL.

Further, according to the embodiment, all of the authenticated printing jobs AJ1, AJ4, and AJ5 associated with the user UA (authenticated user) are executed, but the present invention is not limited to such an example. For example, only a part of the authenticated printing jobs AJ1, AJ4, and AJ5 associated with the user UA (authenticated user) may be executed. Specifically, a predetermined number of authenticated printing jobs AJ out of the plurality of the authenticated printing jobs AJ1, AJ4, and AJ5 may be sequentially executed in the order reverse of the order of storing in the storing unit 5.

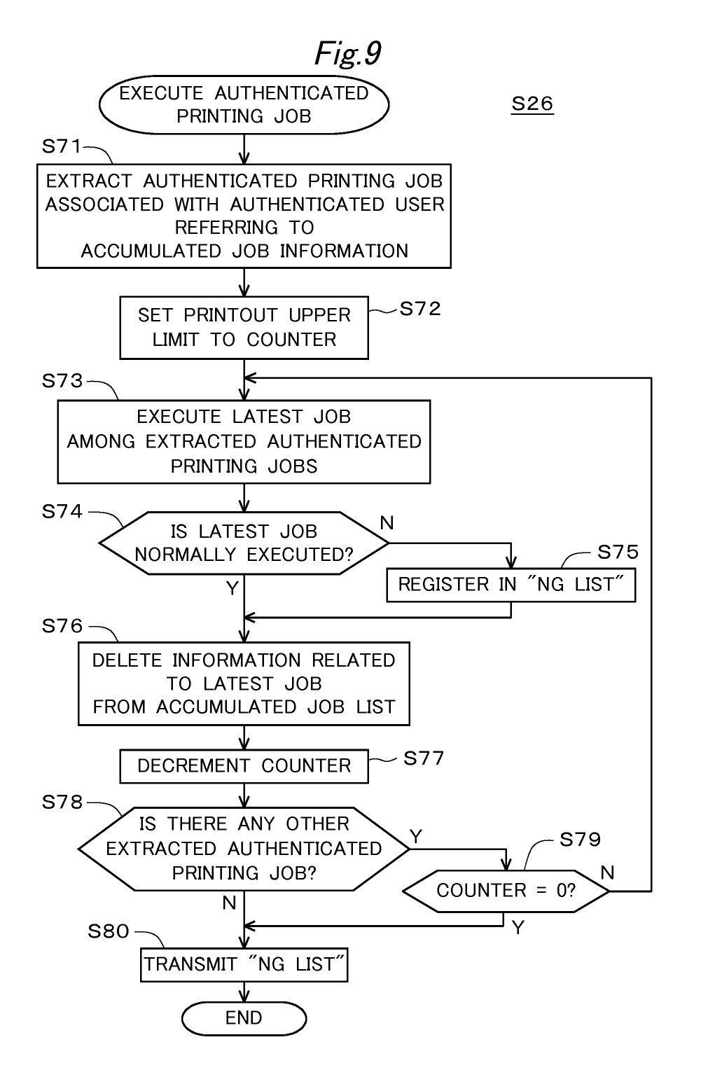

Specifically, the MFP 10 may executes processing as shown in flowchart of FIG. 9 in Step S26 of FIG. 5. In the following, the operation of the MFP 10 when an upper limit of the printout of the authenticated printing job AJ is set to be “1” will be described according to the flowchart of FIG. 9.

First, the MFP 10 extracts the authenticated printing jobs AJ1, AJ4, and AJ5 associated with the user UA (authenticated user) from the storing unit 5 using the extracting unit 13 (Step S71).

Then, the MFP 10 sets a counter to have a printout upper limit “1” for the authenticated printing job AJ (Step S72).

Thereafter, the MFP 10 executes the authenticated printing job AJ5 which is a latest job out of the authenticated printing jobs AJ1, AJ4, and AJ5 extracted by the extracting unit 13 (Step S74).

When the latest authenticated printing job AJ5 is normally executed (YES in Step S74), the MFP 10 deletes information related to the authenticated printing job AJ5 from the accumulated job information TF (Step S76).

Then, the MFP 10 decrements the counter (Step S77). With this, the counter is changed from “1” to “0”.

Thereafter, the MFP 10 determines whether or not there is another authenticated printing job AJ extracted by the extracting unit 13 (Step S78).

In this case, it is determined that there are the authenticated printing jobs AJ1 and AJ4 extracted by the extracting unit 13 (YES in Step S78), and the process moves to Step S79.

In Step S79, the MFP 10 determines whether or not the counter is “0”. Here, the process moves to Step S80 if the counter is “0”, and otherwise returns to Step S73.

In this case, the counter is determined to show “0” (YES in Step S79), and the process of the MFP 10 moves to Step S80.

In Step S80, an NG list is transmitted to the user UA by e-mail using the transmitting unit 17.

According to such a configuration, the authenticated printing job AJ (specifically, AJ5) that is relatively new out of the plurality of authenticated printing jobs AJ1, AJ4, and AJ5 may be executed and printed in a limited way. For example, as in the above example, when the printout upper limit is set to be “1”, the authenticated printing job AJ executed by the printout control unit 15 is limited to “1”, and as a result, only the latest authenticated printing job AJ5 out of the plurality of authenticated printing jobs AJ1, AJ4, and AJ5 may be executed.

Further, according to the above modified example (Step S26 in FIG. 9), the upper limit of the printout that is previously set is “1”, but the upper limit of the printout may be set for each user, or may be transmitted when transmitting the authenticated printing job AJ from the client computer 30.

Moreover, according to the embodiment, the user authentication of the user UA and the login of the user UA to the MFP 10 are performed using the authenticating unit 70 in Step S22 of FIG. 5, but the present invention is not limited to such an example. For example, only the user authentication of the user UA may be performed using the authenticating unit 70 (without performing the login to the MFP 10). According to such a configuration, it is possible to execute the authenticated printing jobs AJ1, AJ4, and AJ5 associated with the user UA without logging in of the user UA to the MFP 10.

Furthermore, according to the embodiment, the authenticating unit 70 is configured as the IC card reader, but the present invention is not limited to such an example. For example, the authenticating unit 70 may be configured as a biometric authentication unit that recognizes individual physical characteristics (such as a fingerprint, a palm print, and vein patterns).

While the invention has been shown and described in detail, the foregoing description is in all aspects illustrative and not restrictive. It is therefore understood that numerous modifications and variations can be devised without departing from the scope of the invention.

What is claimed is:

1. An image forming apparatus comprising:
an input-operation accepting unit configured to accept an input operation by a first user currently logged in the image forming apparatus;
a receiving unit configured to receive an authenticated printing job from a second user different from the first user;
a storing unit configured to store the authenticated printing job in association with the second user;
an authenticating unit provided separately from the input-operation accepting unit, and configured to authenticate the second user in parallel with acceptance processing of the input operation by the first user using the input-operation accepting unit;
an extracting unit configured to extract the authenticated printing job associated with the second user from the storing unit upon authentication of the second user by the authenticating unit; and
a print control unit configured to execute the authenticated printing job extracted by the extracting unit.

2. The image forming apparatus according to claim 1, wherein
the print control unit executes the authenticated printing job after a job that has been executed by the first user currently logged in the image forming apparatus is completed.

3. The image forming apparatus according to claim 2, wherein
the job includes a job accompanied by printing.

4. The image forming apparatus according to claim 1, wherein
the print control unit executes the authenticated printing job when a non-operating time period is longer than a predetermined time period, the non-operating time period being obtained by counting time elapsed after the input operation is last accepted by the input-operation accepting unit.

5. The image forming apparatus according to claim 1, wherein
the receiving unit sequentially receives a plurality of authenticated printing jobs each being the authenticated printing job from the second user,
the storing unit stores the plurality of authenticated printing jobs separately in association with the second user,
the extracting unit extracts the plurality of authenticated printing jobs associated with the second user, and
the print control unit sequentially executes the plurality of authenticated printing jobs in an order reverse of an order of storing in the storing unit.

6. The image forming apparatus according to claim 5, wherein
the print control unit sequentially executes a predetermined number of authenticated printing jobs out of the plurality of authenticated printing jobs in the order reverse of the order of storing in the storing unit.

7. The image forming apparatus according to claim 5, further comprising:
a transmitting unit configured to transmit information to the second user, the information being related to any of the plurality of authenticated printing jobs of which the print control unit has failed to print out.

8. An image forming system comprising:
an input-operation accepting unit configured to accept an input operation by a first user currently logged in an image forming apparatus;
a receiving unit configured to receive an authenticated printing job from a second user different from the first user;
a storing unit configured to store the authenticated printing job in association with the second user;
an authenticating unit provided separately from the input-operation accepting unit, and configured to authenticate the second user in parallel with acceptance processing of the input operation by the first user using the input-operation accepting unit;
an extracting unit configured to extract the authenticated printing job associated with the second user from the storing unit upon authentication of the second user by the authenticating unit; and
a print control unit configured to execute the authenticated printing job extracted by the extracting unit.

9. A non-transitory computer-readable recording medium storing a program for causing a computer built within an image forming apparatus to execute the steps of:
a) accepting an input operation by a first user currently logged in the image forming apparatus using an input-operation accepting unit;
b) receiving an authenticated printing job from a second user different from the first user;
c) storing the authenticated printing job in association with the second user in a storing unit;
d) authenticating the second user using an authenticating unit provided separately from the input-operation accepting unit and configured to perform user authentication in parallel with acceptance processing of the input operation by the first user using the input-operation accepting unit;
e) extracting the authenticated printing job associated with the second user from the storing unit upon authentication of the second user by the authenticating unit; and
f) executing the authenticated printing job extracted in the step e).
